(19) United States
(12) Patent Application Publication
(10) Pub. No.: US 2007/0091436 A1
(43) Pub. Date: Apr. 26, 2007

(54) Rear projection display screen

(75) Inventors: Yuichi Aoki, Niigata (JP); Kenichi Yakushiji, Niigata (JP); Keisuke Adachi, Niigata (JP); Masatoshi Niwa, Niigata (JP)

Correspondence Address: CONNOLLY BOVE LODGE & HUTZ LLP, P.O. BOX 2207, WILMINGTON, DE, 19899-2207, US

(73) Assignee: Arisawa Mfg. Co., Ltd., Joetsu-shi (JP)

(21) Appl. No.: 10/577,479

(22) PCT Filed: Oct. 27, 2004
(86) PCT No.: PCT/JP04/16348

§ 371 Date: Apr. 27, 2006

(30) Foreign Application Priority Data
Oct. 30, 2003 (JP) 2003-370509
Oct. 19, 2004 (JP) 2004-303901

(51) Int. Cl. G03B 21/56

(52) U.S. Cl. 359/460

(57) ABSTRACT

The present invention provides a rear projection display screen exhibiting an extremely excellent practicability which can realize the prevention of reflection with no color slurring and can prevent the generation of a ghost image. In a rear projection display screen which includes a first optical member which converts a diffusion light from a light source into a collimated light, and a second optical member which converts the collimated light output from the first optical member to light having a proper output angle-luminosity distribution in the order from the light source side, at least a light-source side surface of the second optical member has a refractive index distribution.

### TECHNICAL FIELD

The present invention relates to a rear projection display screen which can suppress the generation of an abnormal image focusing phenomenon such as a ghost image.

### BACKGROUND ART

In general, a rear projection display device mainly includes three kinds of parts, that is, an optical engine which is a part for forming an image, an optical system which projects an image light output from the optical engine to a projection- screen, and the projection screen which receives the image light.

Among these parts, the projection screen which is arranged at a position closest to an observer is constituted of two kinds of optical members, wherein a first optical member which is arranged on a light source side has a function of converting a diffusion light from a light source into a collimated light, and a second optical member which is arranged on an observer's side has a function of converting the collimated light output from the first optical member into light having a proper output angle-luminosity distribution. A Fresnel lens is used as the first optical member in general, while the second optical member is generally referred to as a lenticular plate and various optical elements can be used as the second optical member. Here, in many cases, on a side closest to the observer, that is, on the further outside of the second optical member, a plate which forms anti-reflection films on both surfaces thereof is arranged so as to reduce a reflection light of an external light.

An image light which is output from the display engine is, when the image light arrives at the projection screen, enlarged by the optical system to have a cross section which agrees with an effective display region of the projection screen and hence, a luminous flux from the display engine is defused in the direction toward the observer. However, all of the image lights output from respective pixels are not always diffused in the same direction. Since the direction that the intensity of the output image light becomes maximum differs for every pixel and hence, when the projection screen which has no pixel light diffusion angle adjusting function is used, it is impossible to provide the same display quality over the whole display screen to observers watching the projection screen from any directions. This is because that the viewing angle-brightness distribution characteristic differs for every pixel.

Here, there has been known a design concept that it is necessary for a data display, for example, the monitoring of a computer to provide the same display quality over the whole screen to any observers who watch the projection screen in an effective viewing angle range. To realize such a design concept, it is necessary that the individual pixel lights which are output from all pixels which constitute the screen are diffused such that the intensities of the individual pixel lights become equal in any output angle directions within the effective viewing angle. When such a diffusion screen is used, the observer who is located at a boundary portion between the inside and the outside an effective viewing angle range, observes a sharp change of display quality even with an extremely slight movement of a viewing point. However, fundamentally, one user, that is, one viewer observes the display and hence, it is considered that there arises no problem in observing the display screen.

Further, there has been also a design concept that it is preferable that the display quality is gradually changed corresponding to the position of the observer within the effective viewing angle range. This design concept is considered to be suitable for using the display screen which is observed by a large number of observers, that is, a television receiver set. In many cases, a diffusion pattern is designed such that the brightness becomes maximum when the viewer is positioned right in front of the screen, that is, when a viewing angle (an angle which is made by a perpendicular to a screen surface and a line of vision of the observer)=0° and the brightness is gradually lowered along with the inclination of the viewing angle. Most of the projection displays which have been marketed currently are designed to aim at the acquisition of such a characteristic. Also in this case, it is necessary to set the diffusion patterns of the output lights from all pixels equal.

To allow the respective pixel lights output from all pixels on the projection screen to have the same diffusion pattern, it is necessary to carry out corrections using the optical system with respect to the individual pixel lights which arrive at the projection screen from the display engine through the magnification optical system and have the angular distribution of respectively different luminosities.

That is, the above-mentioned object can be achieved by providing microlenses which correct optical axes (the directions which indicate the maximum luminosities) and diffusion angles at respective positions on the projection screen corresponding to the respective pixels.

However, the accurate arrangement of the microlenses at positions on the projection screen corresponding to a large number of pixels requires an extremely precise positioning manipulation and hence, a facility for realizing such manipulation requires a huge expense and, at the same time, the productivity is low whereby a manufacturing cost becomes excessively large.

Further, such a microlens array is designed to be combined with particular optical system and display engine and hence, the microlens array lacks the versatility whereby the manufacturing cost is further pushed up.

Accordingly, to obviate the positioning manipulation of the pixels on the display engine side and the pixels on the projection screen, the microlenses which are arranged on the projection screen are divided into a plurality of groups in general. In this case, provided that a pitch of the microlenses arranged on the projection screen is set to ⅕ or less of the pixel pitch, it is considered that the lowering of the resolution which can be observed with naked eyes does not occur even when some positional displacement is generated.

On the other hand, the designing and the manufacture of respective microlenses which correct optical axes and diffusion angles of output lights from respective pixels on the projection screen are extremely cumbersome and difficult and hence, in a currently adopted method, the output lights are once collimated to convert the whole incident lights into collimated lights and the correction of optical axes is not performed by the microlens array.

That is, first of all, a Fresnel lens is arranged on the optical engine side of the projection screen as the first optical member to perform the collimation, and diffusion angles of collimated lights output from the Fresnel lens are corrected by the microlens array. Since the image lights which are incident on the microlens array are collimated lights, broadening of the output lights with the angular distribution, that is, correction of diffusion angles becomes the most important function of the microlens array. The angular distribution is determined by a curved surface shape of unit cells which constitute the microlens array.

Currently, substantially all projection display screens adopt the constitution described above.

As the microlens array which constitutes the second optical member for performing the diffusion angle correction function, a ball grid array, a cylindrical lens array, a fly-eye lens, a prism array or the like may be used.

As one of drawbacks which arise in such an optical system, a ghost image may be named. This ghost image is a phenomenon in which lights that are reflected on surfaces of respective optical members form images by repeating the reflections in a housing, wherein the ghost image is formed by the reflection of the lights on the surfaces of the optical members arranged inside the optical path. As the optical member is arranged more closely to the observer side and the reflection surface has larger unevenness, apart from the flat surface, the generation of the ghost image is largely influenced.

The screen includes at least four surfaces. That is, in the order from the observer's side, the surface on the observer's side of the second optical member, the surface on the light source side of the second optical member, the surface on the observer's side of the first optical member, and the surface on the light source side of the first optical member. Usually, the first optical member adopts the planar side as an input surface thereof, and the planer side of the second optical member is used as an output surface.

Accordingly, among these input and output surfaces, the non-flat surfaces are constituted of the light-source-side surface of the second optical member and the observer-side of the first optical member. As a result, the reflection light on the optical-source-side surface of the second optical member becomes a primary cause of the generation of the ghost.

In view of the above, by forming an anti-reflection film on the reflection surface, it is possible to suppress the generation of the ghost formed by the reflection light to some extent.

However, the anti-reflection film which is used in general is, in a typical description, an anti-reflection film which makes use of the interference and is constituted of, from an air side, a low refractive index layer having a thickness of ¼ of a center wavelength, a high refractive index layer having a thickness of ½ of the center wavelength, and an intermediate refractive index layer having a thickness of ¼ of the center wavelength or an equivalent film. Such an anti-reflection film has a drawback that a wavelength characteristic of the anti-reflection film is largely shifted depending on an incident angle thus causing color slurring. The light-source-side surface of the second optical member is formed of the microlens or the prism array, and the observer-side surface of the first optical member is formed of the Fresnel lens and hence, considerably steep unevenness is formed on these surfaces. Accordingly, the color slurring occurs in the general anti-reflection film and it is impossible to effectively suppress the generation of the ghost image.

### DISCLOSURE OF THE INVENTION

The invention has been made to overcome the above-mentioned drawbacks and it is an object of the invention to provide a rear projection display screen exhibiting an extremely excellent practicability which can realize the anti-reflection without color slurring and the generation of a ghost image by allowing at least a light-source-side surface of a second optical member to have the refractive index distribution which prevents the reflection.

The gist of the invention is explained in conjunction with attached drawings.

In a rear projection display screen which includes a first optical member that converts a diffusion light from a light source into a collimated light, and a second optical member that converts the collimated light output from the first optical member to light having a proper output angle-luminosity distribution in the order from the light source side, at least a light-source side surface of the second optical member has a refractive index distribution.

Further, in the rear projection display screen described in claim 1, the refractive index distribution is set to gentle distribution such that the refractive index of a portion which is brought into contact with air assumes a lowest value and the refractive index of a portion remotest from the air assumes a highest value.

Further, in the rear projection display screen described in either one of claim 1 and claim 2, the refractive index distribution is set by changing an average refractive index which is determined based on an abundance ratio between a plurality of convex portions formed on a surface of the second optical member and air which fills gaps defined between the convex portions in the direction perpendicular to the surface of the second optical member.

Further, in the rear projection display screen described in claim 3, the convex portions are formed through a step in which a liquid material containing at least one kind of curing material is applied to a surface of a base body and, thereafter, the curing material is cured, and a step in which uncured portions of the curing material are removed.

Further, in the rear projection display screen described in claim 4, a solution which mixes a liquid crystal material, a polymerized monomer and an oligomer therein is adopted as a liquid material.

By adopting the above-mentioned constitution, the invention can provide the rear projection display screen exhibiting an extreme practicability which can realize the anti-reflection with no color slurring and can prevent the generation of a ghost image.

### BRIEF DESCRIPTION OF THE DRAWINGS

FIG. 1 is a schematic explanatory view of an embodiment of the invention.

### BEST MODE FOR CARRYING OUT THE INVENTION

Preferred embodiments of the invention are briefly explained with the manner of operation and advantageous effects in conjunction with drawings.

By adopting the distribution which allows the refractive index on a light-source-side surface of at least a second optical member to prevent the reflection, when a diffusion light from the light source side is incident on a screen, the reflection of the diffusion light on the light-source-side surface of the second optical member is interrupted. That is, different from the conventional anti-reflection which is performed by making use of the interference by inverting phases of reflection lights, it is possible to realize the anti-reflection which has no wavelength dependency and, has no fear of generating color slurring, and hence, it is possible to interrupt the generation of a ghost image.

Accordingly, the invention can provide the rear projection display screen exhibiting the extreme practicability by realizing the anti-reflection with no color slurring thus preventing the generation of the ghost image.

A specific example of the invention is explained in conjunction with a drawing.

According to this embodiment, in the rear projection display screen which includes a first optical member which converts a diffusion light from a light source into a collimated light, and a second optical member which converts the collimated light output from the first optical member to light having a proper output angle-luminosity distribution in the order from the light source side, a light-source side surface of the second optical member has a refractive index distribution.

A known Fresnel lens is adopted as the first optical member, while a known lenticular plate (a cylindrical lens array) is adopted as the second optical member. Here, a fly-eye lens may be adopted as the second optical member.

The distribution of refractive index is set to a gentle distribution in which the refractive index of a portion which is brought into contact with air assumes a lowest value and the refractive index of a portion remotest from the air assumes a highest value.

Accordingly, the second optical member has no jumping of the refractive index in the inside thereof and hence, it is possible to suppress the refractive index to an extremely small value.

To be more specific, the distribution of refractive index is set by changing the average refractive index which is determined by an abundance ratio between a plurality of convex portions formed on a surface of the second optical member and air which fills gaps between the convex portions in the direction perpendicular to a surface of the second optical member.

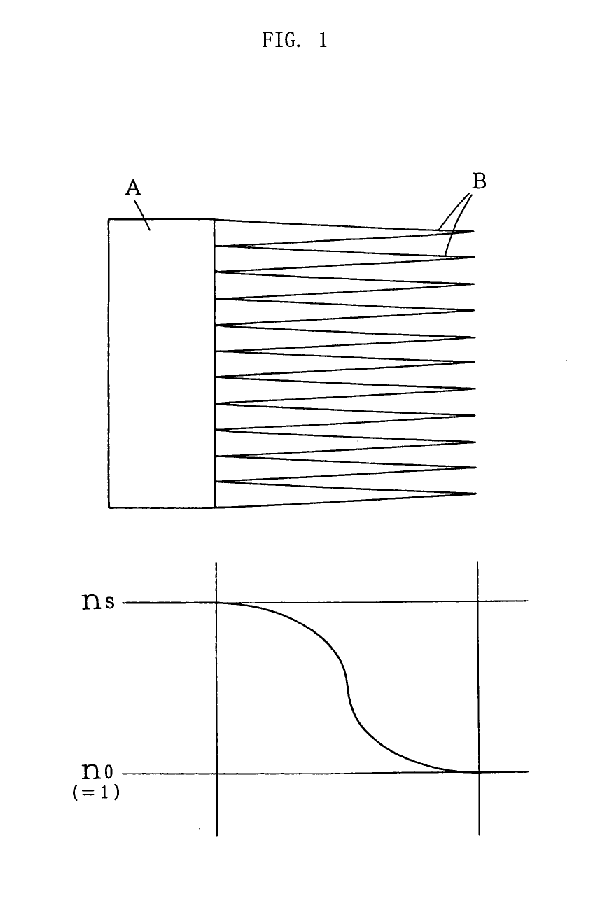

Accordingly, as illustrated in FIG. 1, by gently changing a cross-sectional area of the convex portions B on the surface of the optical member A in the depth direction, that is, in the direction perpendicular to a contact flat surface with respect to the surface having a complicated shape, it is possible to allow the refractive index n to be changed gently.

A reflectance reduction effect based on the anti-reflection mechanism attributed to the distribution of refractive index formed by these plural convex portions can be imparted in an extremely wide band since the anti-reflection mechanism has no wavelength dependency different from a usual anti-reflection film inverts phases of reflection lights by allowing two luminous fluxes reflecting on both surfaces of a thin film to have an optical length difference of a half wavelength and to interfere with each other thus bringing the intensity to 0. Accordingly, it is possible to realize the anti-reflection without color slurring.

It is necessary to set the sizes of the convex portions as minute as possible to an extent that the light is not scattered. That is, since a usable shortest wavelength is approximately 400 nm, a diameter of a bottom surface is at least 40 nm or less, preferably 20 nm or less. A length of the convex portion is 50 nm or more and 10 μm or less, preferably, 100 nm or more and 1 μm or less.

As methods for forming such a structure, following various methods can be used.

a: two luminous-flux interference exposure of light curing resin

b: EB modulation drawing applied to an electron beam resist film formed on a substrate and reactive ion etching using gas which optimizes a selection ratio

c: phase separation which is caused by adjusting solubilities of a plurality of components

d: plasma etching applied to a surface of a formed body (first optical member or second optical member).

Among these methods, although the methods a and b are techniques which require a considerable cost, in most cases, the first optical member and the second optical member to which these methods a and b are applied are manufactured by forming using a mold and hence, it is possible to adopt a method which builds such a structure in a surface of the mold preliminarily. However, due to an anchoring effect which is brought about by an extremely small size of the convex portions, the removal of the optical member from the mold becomes extremely difficult. Further, the shape of the surface to which the method is applied is not flat and hence, it is extremely difficult to apply the above-mentioned methods a and b to a curved surface whereby the methods a and b are not proper.

On the contrary, the method c makes use of a self-organizing phenomenon and hence, the method does not require a considerably large expense whereby the method can be individually applicable to a product per se. Accordingly, drawbacks such as the difficulty in removing the optical member from the mold do not arise. Further, since the optical member is formed by applying liquid by coating and, thereafter, by curing a portion of the liquid and hence, the application to a curved surface is not also difficult.

Here, in the method d, plasma is generated in the vicinity of a surface of a formed body (a Fresnel lens or a-fly-eye lens) thus exposing the surface to the plasma, atoms in a surface region are beat out by energy of the plasma, and projections which are formed in an island-like shape are formed by the non-uniform re-adhesion of the atoms.

As the method c, it is possible to consider a method in which a solution containing a plurality of components which worsen the compatibility after one component is cured is applied by coating and, thereafter, a hardened material is formed by phase separation during a curing reaction and a method which forms the phase separation structure by making use of components having some self-organizing property. However, it may be possible to suitably combine these two methods. In either one of these methods, after the curing reaction, uncured portions are removed by leaching thus forming gap portions or cavity portions.

Further, in forming the convex portions using the method c, as a material thereof, following two systems are named.
1) mixture of liquid crystal and polymerized composition
2) non-polymerized material except for polymerized composition and liquid crystal

In the above-mentioned two systems, the system 1) can make use of the self-organizing action of the liquid crystal material and hence, it is possible to use the larger number of materials compared to the material 2). In the case of the material 2), it is necessary to design the compatibility carefully.

Usually, when the liquid crystal is used, the designing of the material system is easy and hence, a coating solution is produced by mixing the liquid crystal material, the polymerized monomer and oligomer. As the curing composition, the use of the curing resin composition which provides the three-dimensional cross-linking structure is desirable to provide the resistance to the leaching step which follows later.

The coating liquid is applied to a surface of the optical member which is formed by casting or molding. Although any technique is applicable as a coating method, spin coating may be advantageous for the adjustment of a film thickness on a minute curved surface. Although the film thickness may by 50 nm or more and 10 μm or less, and preferably 100 nm or more and 1 μm or less, the film thickness can be adjusted based on the viscosity of the curing composition and the rotational speed.

To obtain the proper film thickness, the curing solution which is applied to the surface of the optical member by coating is left for a fixed time. At a state that the self-organizing of the liquid crystal material progresses to some extent, energy for curing is added. Here, as the energy to be added, heat, ultraviolet rays, radiation or the like may be considered. However, when the thermal polymerization is performed, the possibility that a phase separated state is broken by the convection which is induced by the temperature distribution is increased. Further, when the radiation polymerization is adopted, there exists a possibility that a reaction occurs in a group other than reactive atomic groups and hence, there exists a possibility that a liquid crystal phase may be cured. Accordingly, the curing of a portion of a curing composition which is subjected to phase separation by the ultraviolet ray polymerization gives rise to a favorable result.

After the curing reaction is finished, from the optical member which holds the liquid crystal phase and the cured portion on a surface thereof, only the uncured liquid crystal material is removed by the leaching manipulation. For performing the leaching, a solvent which resolves the used liquid crystal material is used. With respect to the curing portion, the composition which generates a cross-linking reaction three dimensionally is designed and used as the curing composition usually and hence, there is no possibility that liquid crystal phase is resolved by the leaching manipulation. However, the curing composition is in a more easily resolvable state compared to the polymer in a bulk state and hence, it is preferable to select a solvent which can easily resolve the liquid crystal material and, on the other hand, cannot easily resolve the material of the curing phase.

To set the size of the gaps or cavities generated by leaching to the targeted 40 nm or less, the viscosity of the curing composition, the difference of interfacial energy with the liquid crystal or the like is adjusted. Here, the liquid crystal which is removed by leaching can be recycled by recovering.

After leaching, with respect to the optical member which has only the cured convex portions on the surface thereof, it is possible to further strengthen the structure by completing the curing reaction by post-baking.

Here, this embodiment adopts the constitution in which the anti-reflection structure which is constituted of such convex portions is formed on the light-source-side surface of at least the above-mentioned second optical member. However, by providing such an anti-reflection structure to an observer-side surface of the first optical member, it is possible to further suppress the generation of the ghost image. Further, such anti-reflection structure may be formed on all surfaces of the first optical member and the second optical member.

However, when the observer-side surface of the second optical member adopts such an anti-reflection structure, it is preferable to arrange a face plate having an anti-reflection multi-layered film which makes use of the interference on an observer-side surface of the anti-reflection structure. This is because of the structure with fine gaps or open pores, when fats and oils are adhered to the structure, has a extreme difficulty in removing the fats and oils, being not applicable to portions which are substantially exposed.

Here, by applying the anti-reflection structure of this embodiment to a surface of the first optical member, that is, a surface of the Fresnel lens, it is possible to obtain the further reliable ghost image suppression effect. Further, on a surface of the first optical member which is parallel to an optical axis of a lens surface which is generally directed to an observer side, a black film may be formed by a suitable coating method such as spin coating.

Since this embodiment is constituted as described, by allowing the refractive index of the light-source-side surface of the second optical member to have the distribution which prevents the generation of reflection, to be more specific, by forming a large number of minute convex portions on the second optical member, due to the refractive index distribution which is formed by the abundance ratio between the convex portions and the air between the convex portions, when the diffusion light is incident on the screen from the light source side, the reflection of the diffusion light on the light source side of the second optical member can be prevented. That is, unlike the conventional anti-reflection which is performed by making use of interference attributed to the inversion of the phases of the reflection lights, it is possible to realize the anti-reflection in which the optical member has no wavelength dependency and there is no fear of the generation of color slurring. Therefore the generation of the ghost image can be suppressed. Accordingly, the embodiment of the invention can provide the rear projection display screen exhibiting the extremely excellent practicability which can realize the anti-reflection with no color slurring and the prevention of the generation of a ghost image.

1. A rear projection display screen comprising:
a first optical member which converts a diffusion light from a light source into a collimated light; and
a second optical member which converts the collimated light output from the first optical member to light having a proper output angle-luminosity distribution in the order from the light source side, wherein
at least a light-source side surface of the second optical member has a refractive index distribution.

2. A rear projection display screen according to claim 1, wherein the refractive index distribution is set to a gentle distribution such that the refractive index of a portion which is brought into contact with air assumes a lowest value and the refractive index of a portion remotest from the air assumes a highest value.

3. A rear projection display screen according to claim 1, wherein the refractive index distribution is set by changing an average refractive index which is determined based on an abundance ratio between a plurality of convex portions formed on a surface of the second optical member and air which fills gaps defined between the convex portions in the direction perpendicular to the surface of the second optical member.

4. A rear projection display screen according to claim 3, wherein the convex portions are formed through a step in which a liquid material containing at least one kind of curing material is applied to a surface of a base body and, thereafter, the curing material is cured, and a step in which uncured portions of the curing material are removed.

5. A rear projection display screen according to claim 4, wherein a solution which mixes a liquid crystal material, a polymerized monomer and an oligomer is adopted as a liquid material.

6. A rear projection display screen according to claim 2, wherein the refractive index distribution is set by changing an average refractive index which is determined based on an abundance ratio between a plurality of convex portions formed on a surface of the second optical member and air which fills gaps defined between the convex portions in the direction perpendicular to the surface of the second optical member.

7. A rear projection display screen according to claim 6, wherein the convex portions are formed through a step in which a liquid material containing at least one kind of curing material is applied to a surface of a base body and, thereafter, the curing material is cured, and a step in which uncured portions of the curing material are removed.

8. A rear projection display screen according to claim 7, wherein a solution which mixes a liquid crystal material, a polymerized monomer and an oligomer is adopted as a liquid material.
